(19) United States
(12) Patent Application Publication
(10) Pub. No.: US 2004/0061681 A1
(43) Pub. Date: Apr. 1, 2004

(54) Mouse having a heat dissipation arrangement

(76) Inventors: Yao-Sheng Shen, Taipei (TW); Ken-Pei Hu, Taipei Hsien (TW)

Correspondence Address: BACON & THOMAS, PLLC, 4th Floor, 625 Slaters Lane, Alexandria, VA, 22314-1176, US

(21) Appl. No.: 10/255,709

(22) Filed: Sep. 27, 2002

(51) Int. Cl. G09G 5/08

(52) U.S. Cl. 345/163

(57) ABSTRACT

The invention is to provide a mouse having a heat dissipation arrangement, which comprises a sensor and at least one vent opening on the surface of the mouse, when one hand of a user holds and operates the mouse coupled to an electronic device, an internal fan installed within the mouse is activated to produce a current of air being guided through the vent opening to the palm in close contact with the surface of the mouse. As a result, it is possible to effectively utilize an unoccupied internal space of the mouse to produce current of air for preventing the hand of user from sweating during operating the mouse.

### FIELD OF THE INVENTION

The present invention relates to pointing devices such as mice and more particularly to an improved mouse having a heat dissipation arrangement.

### BACKGROUND OF THE INVENTION

A conventional ball mouse 1 is shown in FIG. 1 and comprises a cover 10 and a base 12. Within the mouse 1 there are provided a ball 14, two grating wheels 16, two pairs of photosensors 18 each pair associated with the corresponding grating wheel 16, and a control circuit 19. At least one button 11 is provided at a side of the cover 10. In an operation of the mouse 1, rotation of the ball 14 rotates the grating wheels 16. In response, a sensing signal caused by the rotation of the grating wheels 16 is sensed by the photosensors 18. The sensing signal is then sent to the control circuit 19 for processing. As an end, a moving distance and a moving direction of the mouse 1 are obtained by calculation.

Another conventional optical mouse 2 is shown in FIG. 2 and comprises a cover 20 and a base 22. At least one button 21 is provided at a side of the cover 20. Within the mouse 2 there are provided an optical device 24, as a replacement of the ball 14 of the conventional mouse 1 shown in FIG. 1, on about a center of the bottom, a circuit board 26 on the base 22, and a plurality of electronic elements and circuits 28 mounted on the circuit board 26 for maintaining a normal operation of the mouse 2. The optical device 24 comprises a light source 242 for producing light that impinges on a reference surface in contact with the underside of the base 22 for generating an image of the reference surface and an image fetching element 244 for fetching the image of the reference surface. When the mouse 2 rolls over the reference surface the optical device 24 can continuously receive the image fetched by the image fetching element 244 and simultaneously compare the received image with a previous received image for calculating a difference therebetween. Such difference is in turn taken as data for precisely calculating the moving distance and direction of the mouse 2.

Then design about appearance of the mouse 1 is ergonomic for facilitating use. As such, some interior portions of the mouse 1 do not have components mounted therein. Further, the optical device 24 and the circuit board 26 only occupy a small portion of the internal space of the optical mouse 2. Hence, the optical mouse 2 can be made smaller than the mouse 1. However, in fact, the optical mouse 2 still has substantially the same shape and size as the conventional ball mouse 1 due to considerations of custom, ergonomic design of the conventional ball mouse 1, or cost. The only difference between the conventional ball mouse 1 and the optical mouse 2 is that the ball 14 of the former is replaced by the optical device 24 of the latter. In other words, the optical mouse 2 is implemented as a ball-less one. As such, a substantial space as previously occupied by the ball is not utilized by the optical mouse 2. Also, some interior portions of the mouse 2 do not have components mounted therein. Thus, it is desirable to mount at least one device having a specific feature in the unoccupied internal space of either mouse. With such device, it is envisaged that either mouse can incorporate a novel feature or solve problems associated with the use of the optical mouse 2. For instance, a drawback is that sweat given forth by the hand is dropped on the upper surface of the mouse. The hand operating the mouse may feel uncomfortable by such sweat due to a close contact of the hand and the mouse. Thus, it is desirable by consumers and manufacturers that a novel mouse having a heat dissipation arrangement for preventing sweat from giving forth by the hand during operation is disclosed.

### SUMMARY OF THE INVENTION

The invention relates to a mouse having a heat dissipation arrangement. The mouse comprises an internal fan and at least one vent opening on the surface of the mouse. When the hand holds and operates the mouse coupled to an electronic device being activated, a current of air is set up by the fan. The current of air is guide by the vent opening to circulate over the palm which is in close contact with the surface of the mouse. As a result, it is possible of preventing sweat from giving forth by the hand during operation. Thus, it is possible of effectively utilizing an unoccupied internal space of the prior art mouse.

The above and other objects, features and advantages of the present invention will become apparent from the following detailed description taken with the accompanying drawings.

### BRIEF DESCRIPTION OF THE DRAWINGS

FIG. 1 is a perspective view of a conventional ball mouse with a portion cut off to show internal components thereof;

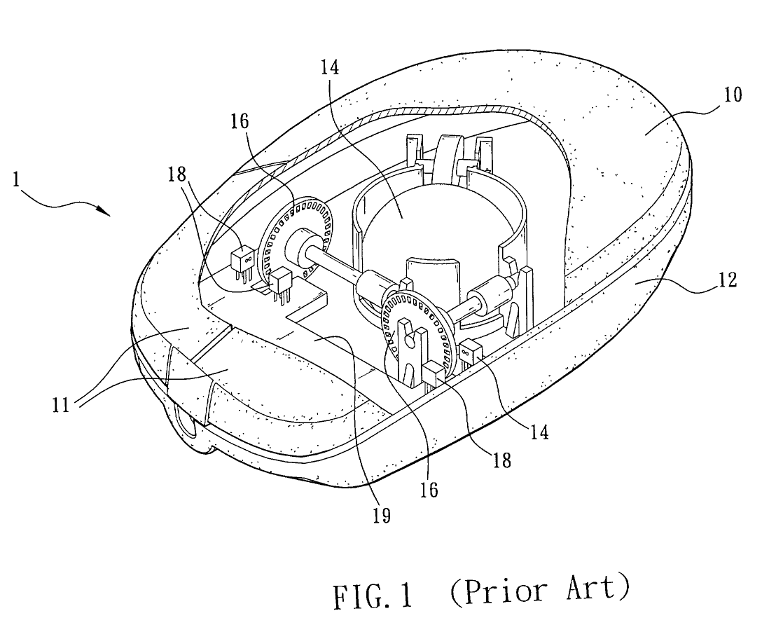

FIG. 2 is a side plan view in part section of a conventional optical mouse for showing internal components thereof;

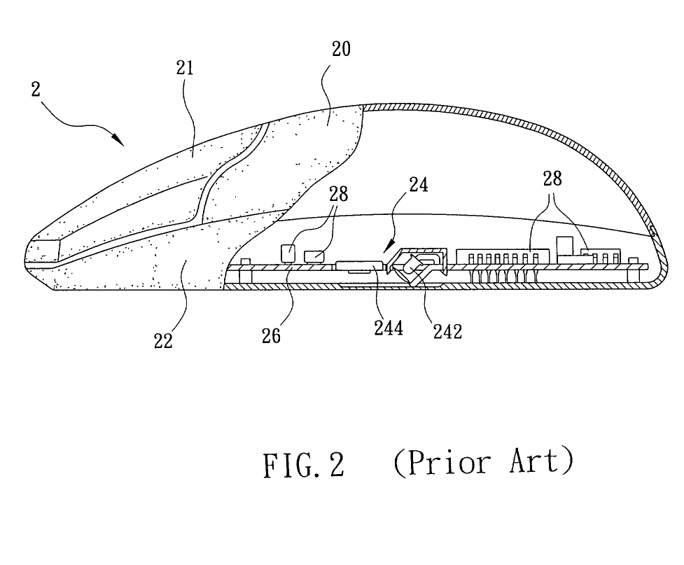

FIG. 3 is a perspective view in part section of a first preferred embodiment of a mouse according to the invention;

FIG. 4 is a side plan view in part section of the mouse shown in FIG. 3 for illustrating a mounting of a fan on a circuit board;

FIG. 5 is a view similar to FIG. 4 for illustrating a mounting of the fan on the top of a base;

FIG. 6 is a view similar to FIG. 4 for illustrating a mounting of the fan on a cover;

FIG. 7 is a view similar to FIG. 5 for illustrating locations of the fan, an air guide, and vent openings of the invention;

FIG. 8 is a perspective view of a second preferred embodiment of a mouse according to the invention with a portion cut off to show internal components thereof; and

FIG. 9 is a side plan view in part section of a third preferred embodiment of a mouse according to the invention for showing internal components thereof.

### DETAILED DESCRIPTION OF THE PREFERRED EMBODIMENTS

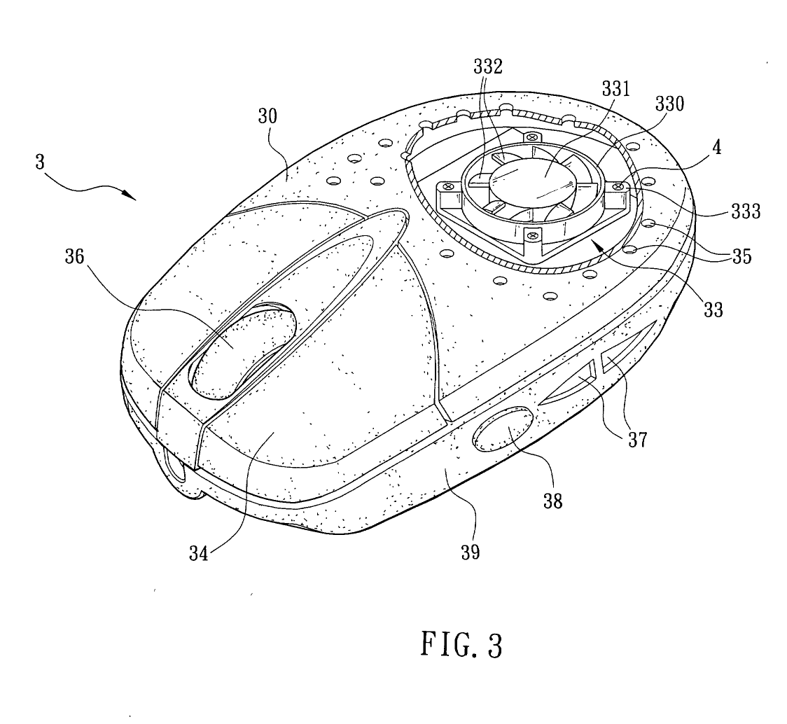

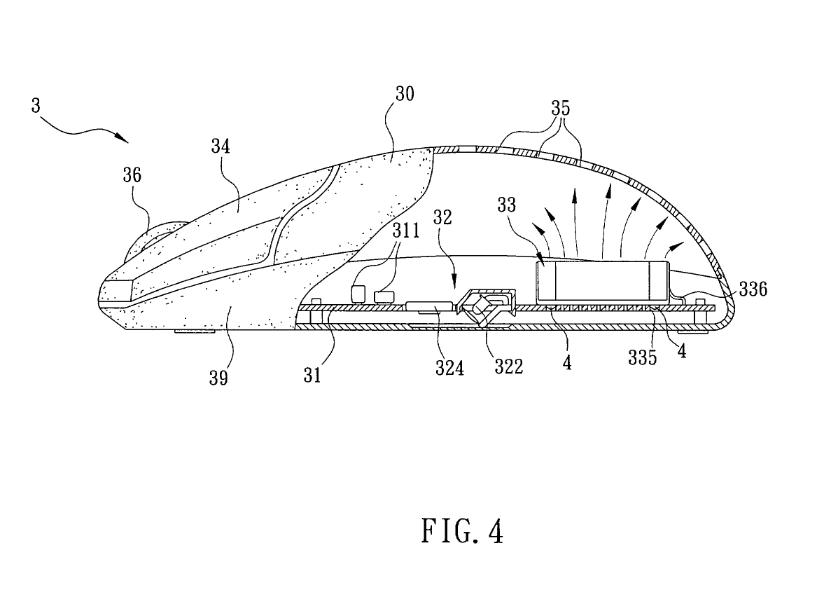

Referring to FIGS. 3 and 4, there is shown a mouse having a heat dissipation arrangement in accordance with the invention. The mouse of the invention is substantially the same in shape as the conventional optical mouse. The mouse comprises a cover 30 and a base 39. Within the mouse 3 there are provided a circuit board 31, a location sensor 32, and a fan 33. A plurality of electronic elements and circuits 311 mounted on the circuit board 31 for maintaining a normal operation of the mouse 3 (including the location sensor 32 and the fan 33). At least one button 34 is provided at a side of the cover 30. At least one vent opening 35 is formed on the surface of the cover 30. In an operation of the mouse 3 which is coupled to an electronic device (e.g., computer) being activated, a moving distance and a moving direction of the mouse 3 can be calculated by the location sensor 32. As such, a pointer shown on the screen of the computer can move along the desired direction a corresponding distance. Also, a current of air set up by the fan 33 flows out of the mouse 3 through the vent openings 35. In a case that the hand holds and operates the mouse 3 the current of air set up by the fan 33 may circulate over the palm which is in a close contact with the cover 30 as the current of air flowing out of the mouse 3 through the vent openings 35. As a result, it is possible of preventing sweat from giving forth by the hand during operation. Hence, the user may feel a degree of comfort. In the invention, a roller 36 for page-up, page-down, or return is provided between the buttons 34. However, the roller 36 is a well known device. Thus a detailed description thereof is omitted herein for the sake of brevity.

Referring to FIG. 4, there is shown a first preferred embodiment of the invention in which the mouse 3 and the location sensor 32 are implemented as an optical mouse and an optical device respectively. The optical device is mounted on the circuit board 31 above about a center of the base 39. Also, the location sensor 32 is electrically coupled to the circuit board 31. The location sensor 32 comprises a light source 322 for producing light that impinges on a reference surface in contact with the underside of the base 39 for generating an image of the reference surface and an image fetching element 324 for fetching the image of the reference surface. When the mouse 3 rolls over the reference surface the location sensor 32 can continuously receive the image fetched by the image fetching element 324 and simultaneously compare the received image with a previous received image for calculating a difference therebetween. Such difference is in turn taken for precisely calculating the moving distance and direction of the mouse 3.

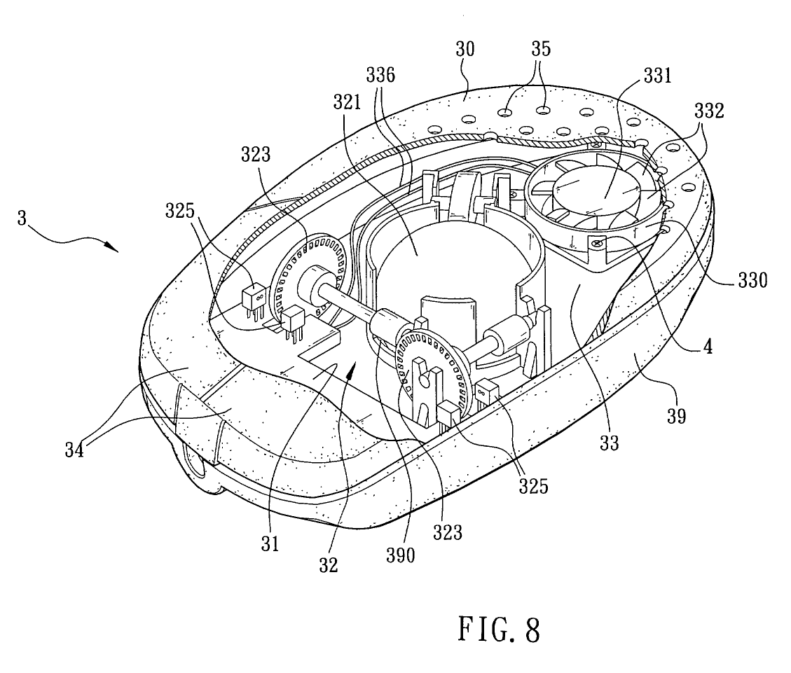

Referring to FIG. 8, there is shown a second preferred embodiment of the invention in which the mouse 3 is a ball mouse. An opening 390 is formed on about the center of the base 39. The circuit board 31 is located on the base 39 adjacent the opening 390. The location sensor 32 comprises a ball 321 rotatably supported at the opening 390, the ball 321 having a portion projected from the base 39, two grating wheels 323 located on the base 39, and two pairs of photosensors 325 each pair associated with the corresponding grating wheel 323, the pairs of photosensors 325 being located on the circuit board 31 and electrically coupled to the circuit board 31 in which each of the grating wheels 323 has one side facing the photosensors 325 and the other side in contact with the ball 321. In an operating state of the mouse rotation of the ball 321 rotates the grating wheels 323. In response, a sensing signal caused by the rotation of the grating wheels 323 is sensed by the photosensors 325. The sensing signal is then sent to the circuit board 31 for being processed by electronic elements and circuits of the circuit board 31. As an end, a moving distance and a moving direction of the mouse are obtained by calculation.

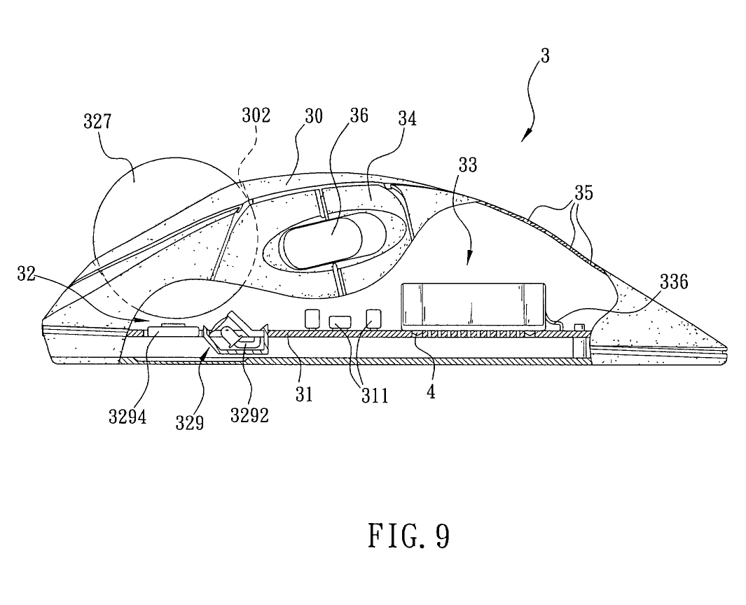

Referring to FIG. 9, there is shown a third preferred embodiment of the invention in which the mouse 3 is implemented as a trackball mouse. A circular opening 302 is formed on the cover 30. The location sensor 32 comprises a trackball 327 rotatably supported at the circular opening 302, the trackball 327 having a portion projected from the circular opening 302 in which preferably, the trackball 327 is formed of a transparent material having powder or a plurality of randomly shaped tiny markings or particles having a light reflection property mixed therein; and an optical device 329 disposed in the mouse 3 adjacent the trackball 327 and electrically coupled to the circuit board 31. In an operating state of the mouse, a light is produced by a light source 3292 of the optical device 329. The light is in turn impinges on and into the trackball 327. As a result, the tiny markings or particles may reflect a portion of the light back to the surface of the trackball 327. Hence, an image fetching element 3294 of the optical device 329 can continuously fetch a clear reflected image. As an end, a moving distance and a moving direction of the trackball 327 are obtained by a precise calculation.

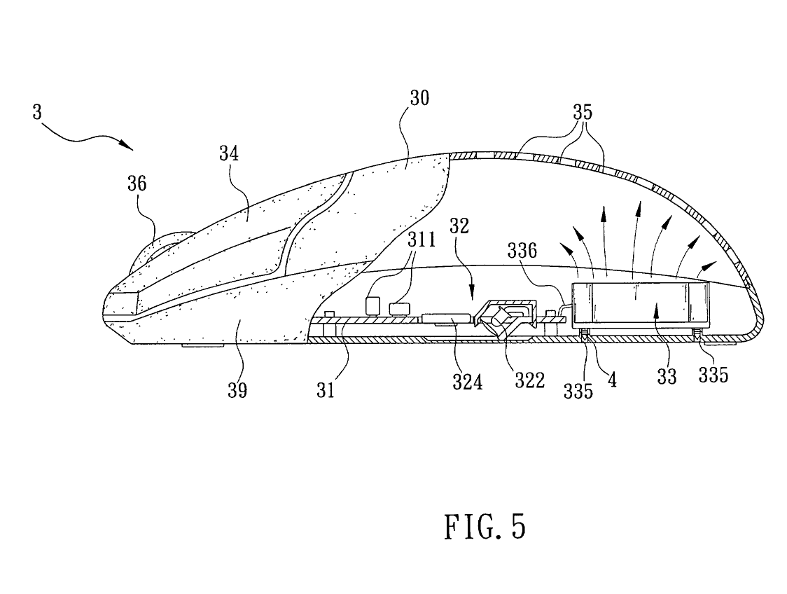

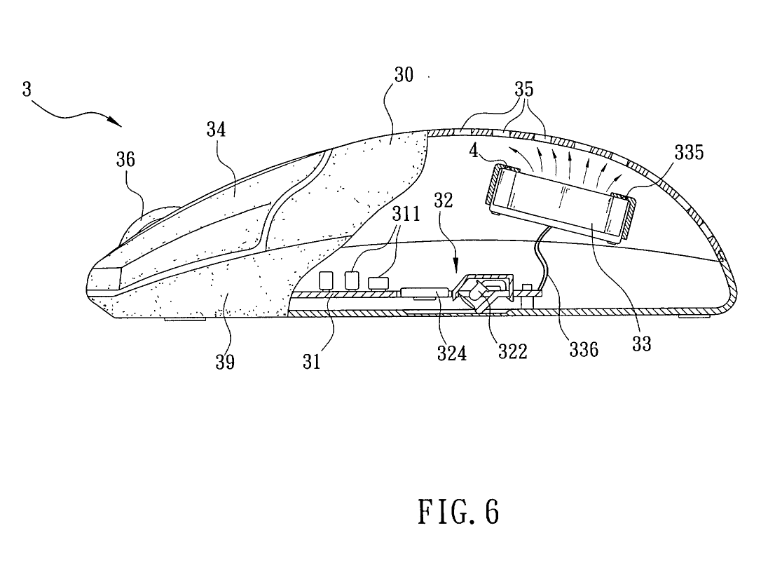

Referring to FIGS. 3, 4, 5, and 6, in a number of configurations of the first preferred embodiment the fan 33 is located on the circuit board 31, on the top of the base 39, and on an inner wall of the cover 30 respectively. The fan 33 is powered by the circuit board 31. The fan 33 comprises a circular frame 330, a central rotary driver 331 defined by the frame 330, a plurality of blades 332 coupled to the rotary driver 331 also defined by the frame 330, and at least one fastening member (four are shown) 333. At least one mating fastening member 335 equal in number to the fastening member 333 is provided in the circuit board 31, the top of the base 39, or the inner wall of the cover 30. As such, the frame 330 can be secured to the circuit board 31, the base 39, or the inner wall of the cover 30 by either fastening the fastening members 333 and the corresponding mating fastening members 335 together or driving a plurality of fasteners 4 through the fastening members 333 and the corresponding mating fastening members 335. A plurality of power cords 336 are electrically coupled to the circuit board 31. Hence, the powered driver 331 can rotate the blades 332 for setting up a current of air to flow out of the mouse 3 through the vent openings 35.

Rotation of the fan 33 after powered on of the mouse 3 irrespective of the mouse 3 being manipulated or not may consume electricity undesirably. Hence, for solving the problem a power saving arrangement is proposed by the invention as referring to FIGS. 3 and 4 again. A power switch 38 is provided on the mouse 3. The power switch 38 is electrically coupled to the circuit board 31 and the fan respectively. Thus, an activation or deactivation of the fan 33 can be controlled by an on/off of the power switch 38. That is, the fan 33 is either activated when the power switch 38 is on or deactivated when the power switch 38 is off for saving energy. The power switch 38 is implemented as a touch power switch. The power switch 38 is suitably located at a position touched by the hand holding the mouse 3. In an operating state of the mouse 3, the touch power switch 38 is on as the hand touches it. In response, the fan 33 rotates. To the contrary, the touch power switch 38 is off as the hand leaves it. In response, the fan 33 stops rotating immediately.

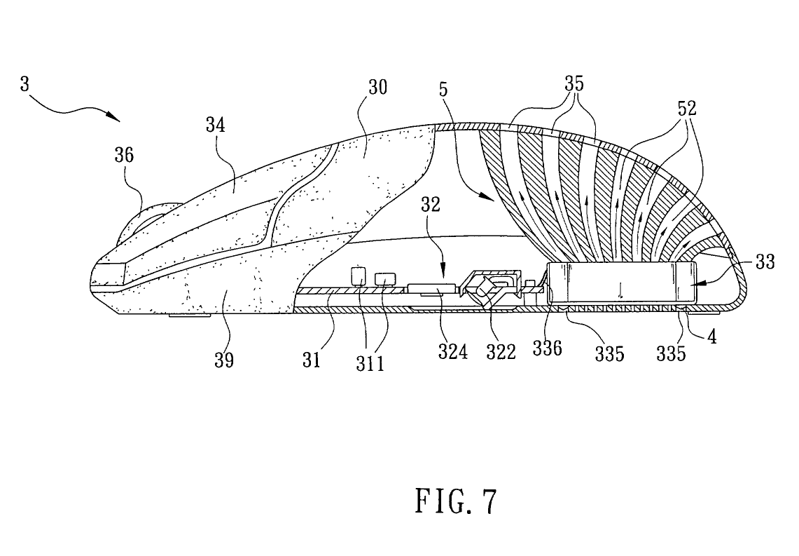

In the invention, at least one opening 37 is formed on at least one side of the base 39 adjacent the cover 30. It is designed that air may circulate through the openings 37 for ventilation when the fan 33 rotates. This is an alternative arrangement for the ventilation of interior of the mouse 3 in case that the vent openings 35 are completed blocked. Moreover, as referring to FIG. 7, there is provided an air guide 5 in the mouse 3 by the invention. The air guide 5 interconnects the fan 33 and the vent openings 35 for guiding the current of air to flow to the vent openings 35. When the fan 33 rotates, a current of air is generated. The current of air is then guided to the vent openings 35 by the air guide 5. Alternatively, the current of air is returned to the fan 33 from the vent openings 35 through the air guide 5. This arrangement can effect an optimum heat dissipation. Also, as shown one end of the air guide 5 is attached to the fan 33 and the other end thereof is in communication with the vent openings 35 in a closed manner. The air guide 5 comprises a plurality of channels 52 each corresponding to the vent opening 35. As such, the current of air can be guided to the vent openings 35 through the channels 52.

It is designed that no excessive heat will be generated by the mouse 3 due to the provisions of the circuit board 31 and the location sensor 32. It is found that heat source of the mouse 3 mainly comes from body heat of the hand holding the mouse 3 in operation. Hence, the current of air generated by the fan 33 preferably flows toward the vent openings 35. In a case that the hand holds and operates the mouse 3 the current of air set up by the fan 33 may circulate over the palm which is in a close contact with the cover 30. As a result, it is possible of preventing sweat from giving forth by the hand during operation.

While the invention has been described by means of specific embodiments, numerous modifications and variations could be made thereto by those skilled in the art without departing from the scope and spirit of the invention set forth in the claims.

What is claimed is:

1. A mouse having a heat dissipation arrangement comprising:
a cover having at least one button at a side thereof;
a base coupled to the cover;
at least one vent opening on a position being held by a user manipulating the mouse;
a circuit board between the cover and the base, the circuit board having a plurality of electronic elements and circuits mounted thereon for maintaining a normal operation of the mouse;
a location sensor between the cover and the base adjacent the base for precisely calculating a moving distance and a moving direction of the mouse; and
a fan between the cover and the base adjacent the base, the fan being electrically coupled to and powered by the circuit board for generating a current of air which flows out of the mouse through the vent opening.

2. The mouse of claim 1, further comprising a roller on the cover adjacent the button for page-scrolling or return.

3. The mouse of claim 1, wherein the mouse is an optical mouse and the location sensor is an optical device respectively, the optical device is mounted on the circuit board above about a center of the base, the location sensor is electrically coupled to the circuit board, and the location sensor comprises a light source for producing light that impinges on a reference surface for generating an image of the reference surface and an image fetching element for fetching the image of the reference surface.

4. The mouse of claim 1, wherein the fan is located on the circuit board.

5. The mouse of claim 1, wherein the fan is located on the base adjacent the circuit board.

6. The mouse of claim 1, wherein the fan is located on an inner wall of the cover.

7. The mouse of claim 1, wherein the fan comprises a peripheral frame, a rotary driver defined by the frame, and a plurality of blades coupled to the rotary driver defined by the frame, and the rotary driver comprises a plurality of power cords electrically coupled to the circuit board so that the blades rotate in response to the driver being powered.

8. The mouse of claim 7, wherein the frame further comprises at least one fastening member, the circuit board further comprises at least one mating fastening member equal in number to the fastening member so that the frame is capable of securing to the circuit board by fastening the fastening member and the corresponding mating fastening members together.

9. The mouse of claim 7, wherein the frame further comprises at least one fastening member, the base comprises at least one mating fastening member equal in number to the fastening member so that the frame is capable of securing to the circuit board by fastening the fastening member and the corresponding mating fastening members together.

10. The mouse of claim 7, wherein the frame further comprises at least one fastening member, the inner wall of the cover comprises at least one mating fastening member equal in number to the fastening member so that the frame is capable of securing to the circuit board by fastening the fastening member and the corresponding mating fastening members together.

11. The mouse of claim 7, further comprising a fastening assembly for securing the fastening member and the corresponding mating fastening member.

12. The mouse of claim 1, further comprising at least one first opening on at least one side of the base adjacent the cover.

13. The mouse of claim 1, further comprising an air guide between the fan and the vent opening for guiding the current of air set up by the fan to flow to the vent opening.

14. The mouse of claim 13, wherein one end of the air guide is attached to the fan, the other end thereof is in communication with the vent opening in a closed manner, and the air guide comprises a plurality of channels each corresponding to the vent opening.

15. The mouse of claim 1, further comprising a power switch on the surface of the mouse, the power switch being electrically coupled to the circuit board and the fan respectively so that an activation or deactivation of the fan is capable of being controlled by an on/off of the power switch.

16. The mouse of claim 15, wherein the power switch is a touch power switch.

17. The mouse of claim 1, wherein the mouse is a ball mouse, further comprising a second opening on about the center of the base wherein the circuit board is located on the base adjacent the second opening and comprises a ball rotatably supported at the second opening, the ball having a portion projected from the base, two grating wheels located on the base, and two pairs of photosensors each pair associated with the corresponding grating wheel, the pairs of photosensors being located on and electrically coupled to the circuit board wherein each of the grating wheels has one side facing the photosensors and the other side in contact with the ball.

18. The mouse of claim 1, wherein the mouse is a trackball mouse, further comprising a circular opening on the cover wherein the location sensor comprises a trackball rotatably supported at the circular opening, the trackball having a portion projected from the circular opening wherein the trackball is formed of a transparent material having powder or a plurality of randomly shaped tiny markings or particles having a light reflection property mixed therein; and an optical device disposed in the mouse adjacent the trackball and electrically coupled to the circuit board.
